(19) United States
(12) Patent Application Publication
(10) Pub. No.: US 2010/0319530 A1
(43) Pub. Date: Dec. 23, 2010

(54) SEALING APPARATUS FOR SQUARE PISTON USED FOR COMPRESSING AND FEEDING FLUID

(76) Inventor: Byung Sue Ryu, Seoul (KR)

Correspondence Address: CHRISTOPHER PAUL MITCHELL, 888 16TH ST., NW, SUITE 800, WASHINGTON, DC, 20006, US

(21) Appl. No.: 12/667,038

(22) PCT Filed: May 16, 2008
(86) PCT No.: PCT/KR08/02740

§ 371 Date: Dec. 28, 2009

(30) Foreign Application Priority Data
Jun. 28, 2007 (KR) 10-2007-0064225

(51) Int. Cl. F16J 9/12

(52) U.S. Cl. 92/198; 92/252

(57) ABSTRACT

A sealing apparatus for a square piston used for compressing and feeding a fluid is applied to equipment used for compressing or feeding the fluid on the basis of a new concept, and maintains a perfectly sealed state to thus guarantee stable operation of the equipment. The sealing apparatus includes a first sealing member having upper, lower, left-hand and right-hand sides and a first square hole in contact with the square piston, a second sealing member having upper, lower, left-hand and right-hand sides and a second square hole in contact with the square piston, first and second elastic means disposed on the upper and right-hand sides of the first sealing member and installed in a cylinder housing, and third and fourth elastic means disposed on the lower and left-hand sides of the second sealing member and installed in the cylinder housing.

### TECHNICAL FIELD

The present invention relates, in general, to a square piston sealing apparatus, and more particularly, to a sealing apparatus for a square piston used for compressing and feeding a fluid, which perfectly seals a gap between the square piston and a cylinder housing, which are used for compressing or feeding various liquids or gases.

### BACKGROUND ART

As is generally known in the art, a fluid compressor (feeder) used for compressing or feeding liquids or gases is designed so that a piston is disposed so as to reciprocate in a cylinder housing having an inlet port and an outlet port. Thus, the fluid compressor draws, compresses, and feeds the fluid using the motion of the piston.

Meanwhile, in order to prevent the fluid from leaking out between the cylinder housing and the piston moving in the cylinder housing as mentioned above, a piston ring is installed between the cylinder housing and the piston. This piston ring is typically installed on the outer circumference of the piston so as to move together with the piston.

As one example, in the case of engine pistons used for various engines, the piston moves in the cylinder housing to which fuel is supplied, and thereby compresses the fuel. When this fuel is compressed, the piston ring is installed on the outer circumference of the piston in order to prevent the fluid from leaking out between the cylinder housing and the piston.

FIG. 6 is a top plan view illustrating the state in which a conventional piston ring is installed. Referring to FIG. 6, the piston ring 10 has a structure in which a slight gap 30 is provided at a portion when opposite ends thereof join each other in consideration of deformation caused by changes in temperature, rather than having a structure in which it completely encircles the outer circumference thereof in the shape of a closed curve. Thus, the piston ring fails to perfectly seal the gap. For this reason, several piston rings are typically installed at predetermined intervals such that the gap portions are not aligned with each other. Thereby, the piston rings prevent the fuel from leaking out.

However, this piston ring configuration does not perfectly seal the gap through which the compressed or flowing fluid leaks out, and thus leads to the leakage of the fluid or the gas. Further, several piston rings must be installed in an offset arrangement at pre-determined intervals. In addition, when the piston rings are worn out, the consumption of fuel is unnecessarily increased, or the output of the engine is lowered.

### DISCLOSURE OF INVENTION

### Technical Problem

Accordingly, the present invention has been made in an effort to solve the problems occurring in the related art, and an object of the present invention is to provide a sealing apparatus for a square piston used for compressing and feeding a fluid, which is applied to equipment used for compressing or feeding the fluid on the basis of a new concept and maintains a perfectly sealed state to thus guarantee stable operation of the equipment.

### BRIEF DESCRIPTION OF THE DRAWINGS

FIG. 1 is a perspective view illustrating a sealing apparatus according to an exemplary embodiment of the present invention;

FIG. 2 is a front view illustrating the state in which a first sealing member of the present invention is installed;

FIG. 3 is a front view illustrating the state in which a second sealing member of the present invention is installed;

FIG. 4 is a cross-sectional view illustrating the state in which a sealing apparatus according to the present invention is installed on a fluid compressor;

FIG. 5 is a detailed view illustrating part A of FIGS. 4; and

FIG. 6 is a top plan view illustrating the state in which a conventional piston ring is installed.

### DESCRIPTION OF SYMBOLS OF THE MAIN PARTS IN THE DRAWINGS

110: first sealing member 120: second sealing member

131: first elastic means 132: second elastic means

133: third elastic means 134: fourth elastic means

### MODE FOR THE INVENTION

The present invention is directed to a sealing apparatus for a square piston used for compressing and feeding a fluid. The sealing apparatus comprises:
a first sealing member, which includes upper, lower, left-hand and right-hand sides in
a square frame structure, and in the middle of which a first square hole is in contact with the square piston required to be sealed;
a second sealing member, which includes upper, lower, left-hand and right-hand sides in a square frame structure, and in a middle of which a second square hole is in contact with the square piston required to be sealed;
first and second elastic means, which are disposed on the upper and right-hand sides of the first sealing member, and are installed in a cylinder housing so as to press upper and right-hand sides of the first hole to be in close contact with upper and right-hand sides of the square piston, respectively; and
third and fourth elastic means, which are disposed on the lower and left-hand sides of the second sealing member, and are installed in the cylinder housing so as to press lower and left-hand sides of the second hole to be in close contact with lower and left-hand sides of the square piston, respectively.

According to the present invention, the sealing apparatus is used to seal a gap between the square piston, having a square cross section, and the cylinder housing, corresponding to the square piston, and is designed so that the two sides of the first hole in the first sealing member and the two sides of the second hole in the second sealing member are in close contact with upper, lower, left-hand and right-hand sides of the square piston so as to maintain a perfectly sealed state. Further, when the first and second sealing members become worn, they brought into even closer contact with the square piston by the first through fourth elastic means, and thus prevent fluid or gas from leaking out due to wear of the sealing members.

Reference will now be made in greater detail to a preferred embodiment of the invention, an example of which is illustrated in the accompanying drawings, and descriptions and details of well-known features and techniques may be omitted to avoid unnecessarily obscuring the subject matter of the invention.

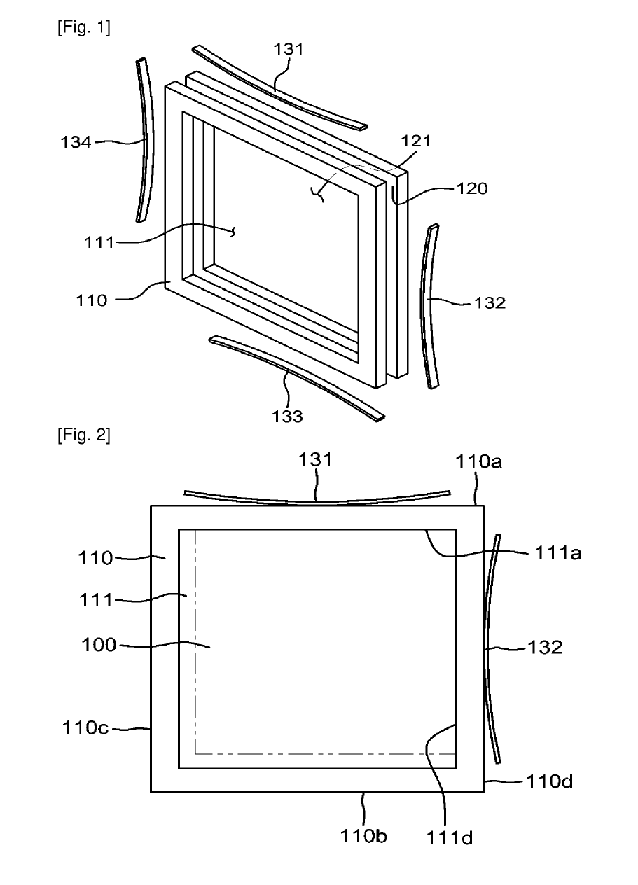

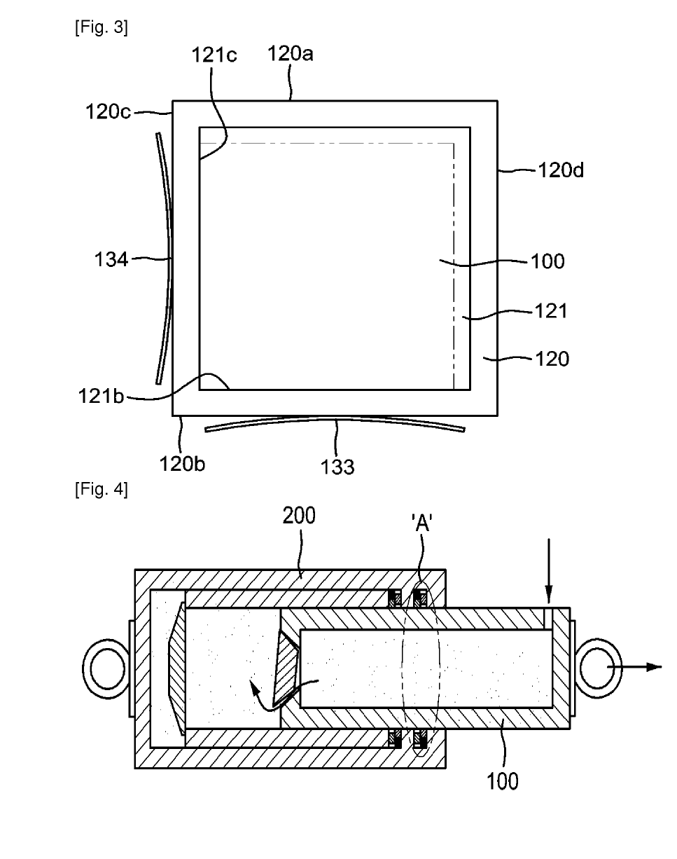

FIG. 1 is a perspective view illustrating a sealing apparatus according to an exemplary embodiment of the present invention. FIG. 2 is a front view illustrating the state in which a first sealing member of the present invention is installed. FIG. 3 is a front view illustrating the state in which a second sealing member of the present invention is installed. Referring to FIGS. 1 through 3, a square piston sealing apparatus according to an exemplary embodiment of the present invention comprises a first sealing member 110, a second sealing member 120, and first, second, third and fourth elastic means 131, 132, 133 and 134. This sealing apparatus is configured so that the first sealing member 110 is elastically supported by the first and second elastic means 131 and 132 so as to maintain part of the square piston 100 in a sealed state, and so that the second sealing member 120 is elastically supported by the third and fourth elastic means 133 and 134 so as to maintain the remaining part of the square piston 100 in a sealed state. A detailed description of each component will be made below.

The first sealing member 110 has the shape of a square frame having upper and lower sides 110a and 110b and left-hand and right-hand sides 110c and 110d, and is provided with a space, i.e. a first square hole 111, in the middle thereof, through which the square piston 100 passes, and which is in contact with the square piston 100.

The second sealing member 120 has the shape of a square frame having upper and lower sides 120a and 120b and left-hand and right-hand sides 120c and 120d, and is provided with a space, i.e. a second square hole 121, in the middle thereof, through which the square piston 100 required to be sealed passes, and which is in contact with the square piston 100.

The first and second elastic means 131 and 132 function to elastically support the first sealing member 110. The first elastic means 131 is disposed on the upper side 110a of the first sealing member 110, while the second elastic means 132 is disposed on the right-hand side 110d of the first sealing member 110. In this manner, the first and second elastic means 131 and 132, which are disposed on the upper and right-hand sides 110a and 110d of the first sealing member 110, keep the upper and right-hand sides 111a and 111d of the first hole 111 to be in close contact with the square piston 100, so that the part of the square piston 100 can be maintained in a sealed state.

The third and fourth elastic means 133 and 134 function to elastically support the second sealing member 120. The third elastic means 133 is disposed on the lower side 120b of the second sealing member 120, while the fourth elastic means 134 is disposed on the left-hand side 120c of the second sealing member 120. In this manner, the third and fourth elastic means 133 and 134, which are disposed on the lower and left-hand sides 120b and 120c of the second sealing member 120, keep the lower and left-hand sides 121b and 121c of the second hole 121 in close contact with the square piston 100, so that the remaining part of the square piston 100 can be maintained in a sealed state.

Meanwhile, the first and second sealing members 110 and 120 are in close contact with each other so as to prevent fluid or gas from leaking out therebetween. Each of the first, second, third and fourth elastic means 131, 132, 133 and 134 employs a leaf spring.

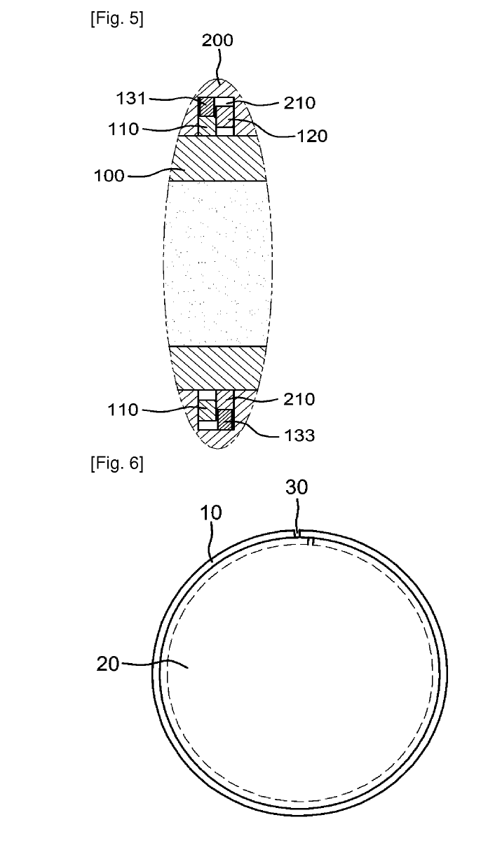

FIG. 4 is a cross-sectional view illustrating the state in which a sealing apparatus according to the present invention is installed on a fluid compressor, and FIG. 5 is a detailed view illustrating part A of FIG. 4. Referring to FIGS. 4 and 5, the first sealing member 110, the second sealing member 120, and the first, second, third and fourth elastic means 131, 132, 133 and 134 are installed on at least one installation section 210, which is formed in a piston housing 200, in which the square piston 100 is mounted. At this time, the first and second elastic means 131 and 132 keep the first hole 111 of the first sealing member 110 in close contact with the upper and right-hand sides of the square piston 100, thereby maintaining the upper and right-hand sides of the square piston 100 in a sealed state. Further, the third elastic means 133 and 134 keep the second hole 121 of the second sealing member 120 in close contact with the lower and left-hand sides of the square piston 100, thereby maintaining the lower and left-hand sides of the square piston 100 in a sealed state.

Meanwhile, in the case in which at least one of the first and second sealing members 110 and 120 is worn due to long-term use, the first sealing member 110 and the second sealing member 120 are kept in close contact with the square piston 100 by the first elastic means 131 and 132 and the third and fourth elastic means 133 and 134, so that they can stably seal the square piston.

In the drawings and specification, typical exemplary embodiments of the invention have been disclosed, and although specific terms are employed, they are used in a generic and descriptive sense only and are not for the purposes of limitation, the scope of the invention being set forth in the following claims.

As described above, according to the present invention, the first and second sealing members maintain the different parts of the square piston in a sealed state while being elastically supported by the first through fourth elastic means, so that they can guarantee a perfectly sealed state using a simple structure. Moreover, even when the sealing members, which are consumable parts, become worn, they can stably seal the square piston, and thus prolong the lifespan thereof.

1. A sealing apparatus for a square piston used for compressing and feeding a fluid, comprising:
a first sealing member (110), which includes upper, lower, left-hand and right-hand sides in a square frame structure, and in a middle of which a first square hole (111) is in contact with the square piston (100), which is required to be sealed;
a second sealing member (120), which includes upper, lower, left-hand and right-hand sides in a square frame structure, and in a middle of which a second square hole (121) is in contact with the square piston (100) required to be sealed;
first and second elastic means (131 and 132), which are disposed on the upper and right-hand sides of the first sealing member (110), and are installed in a cylinder housing (200) so as to press upper and right-hand sides of the first hole (111) to be in close contact with upper and right-hand sides of the square piston (100), respectively; and
third and fourth elastic means (133 and 134), which are disposed on the lower and left-hand sides of the second sealing member (120), and are installed in the cylinder housing (200) so as to press lower and left-hand sides of the second hole (121) to be in close contact with lower and left-hand sides of the square piston (100), respectively.

2. The sealing apparatus as set forth in claim 1, wherein each of the first, second, third and fourth elastic means (131, 132, 133 and 134) includes a leaf spring.
